(19) United States
(12) Patent Application Publication
(10) Pub. No.: US 2024/0152799 A1
(43) Pub. Date: May 9, 2024

(54) GENERATIVE GRAPH MODELING FRAMEWORK

(71) Applicant: ADOBE INC., SAN JOSE, CA (US)

(72) Inventors: Sudhanshu Chanpuriya, Amherst, MA (US); Ryan A. Rossi, San Jose, CA (US); Nedim Lipka, Campbell, CA (US); Anup Bandigadi Rao, San Jose, CA (US); Tung Mai, San Jose, CA (US); Zhao Song, Seattle, WA (US)

(21) Appl. No.: 18/051,364

(22) Filed: Oct. 31, 2022

(51) Int. Cl. G06N 20/00; G06F 7/78

(52) U.S. Cl. CPC G06N 20/00; G06F 7/78

(57) ABSTRACT

Systems and methods for data augmentation are described. Embodiments of the present disclosure receive a dataset that includes a plurality of nodes and a plurality of edges, wherein each of the plurality of edges connects two of the plurality of nodes; compute a first nonnegative matrix representing a homophilous cluster affinity; compute a second nonnegative matrix representing a heterophilous cluster affinity; compute a probability of an additional edge based on the dataset using a machine learning model that represents a homophilous cluster and a heterophilous cluster based on the first nonnegative matrix and the second nonnegative matrix; and generate an augmented dataset including the plurality of nodes, the plurality of edges, and the additional edge.

### BACKGROUND

The following relates generally to data augmentation. Data augmentation or data completion refers to the process of predicting unseen data based on existing data. Data augmentation is a field of data analysis, which is the process of inspecting, cleaning, transforming and modeling data. In some cases, a dataset has missing cell values at certain rows. These rows may not be selected for visualizations, analysis, or training a machine learning model due to incomplete data. Datasets with missing cell values lead to models with poor predictive performance, bias, and lack of generalizability. Additionally, models trained on datasets with missing cell values generate incorrect prediction and visualization (e.g., dashboard application).

Data visualization models often generate visualizations based on a dataset using data points with no missing cell values. In the event that a dataset has data points with missing cell values, data visualization models often exclude the data points with missing cell values. However, these models make inaccurate analyses, visualizations, and predictions because they exclude incomplete (i.e., missing) but important cell values. Therefore, there is a need in the art for an improved data augmentation system that can efficiently manage data completion for datasets.

### SUMMARY

The present disclosure describes systems and methods for data augmentation. Embodiments of the disclosure include a data augmentation apparatus configured to compute a probability of an additional edge based on a dataset. Some embodiments of the present disclosure provide for augmenting datasets using a graph model that includes clusters that are both homophilous (clustered nodes likely to be connected) and heterophilous (clustered nodes unlikely to be connected). The data augmentation apparatus, via the graph model, can predict or fill missing values in the dataset. The graph model is generated based on nonnegative matrix factorization that represents both a homophilous cluster and a heterophilous cluster. In some examples, the graph model is trained to output link probabilities which are interpretable in terms of the clusters (e.g., communities) it detects.

A method, apparatus, and non-transitory computer readable medium for data augmentation are described. One or more embodiments of the method, apparatus, and non-transitory computer readable medium include receiving a dataset that includes a plurality of nodes and a plurality of edges, wherein each of the plurality of edges connects two of the plurality of nodes; computing a first nonnegative matrix representing a homophilous cluster affinity; computing a second nonnegative matrix representing a heterophilous cluster affinity; computing a probability of an additional edge based on the dataset using a machine learning model that represents a homophilous cluster and a heterophilous cluster based on the first nonnegative matrix and the second nonnegative matrix; and generating an augmented dataset including the plurality of nodes, the plurality of edges, and the additional edge.

A method, apparatus, and non-transitory computer readable medium for data augmentation are described. One or more embodiments of the method, apparatus, and non-transitory computer readable medium include receiving a dataset that includes a plurality of nodes and a plurality of edges, wherein each of the plurality of edges connects two of the plurality of nodes; computing a first nonnegative matrix representing a homophilous cluster affinity; computing a second nonnegative matrix representing a heterophilous cluster affinity; computing a predicted probability of an edge of the plurality of edges based on the first nonnegative matrix and the second nonnegative matrix using a machine learning model that represents a homophilous cluster and a heterophilous cluster; and updating parameters of the machine learning model based on the predicted probability of the edge.

An apparatus and method for data augmentation are described. One or more embodiments of the apparatus and method include a processor; a memory including instructions executable by the processor; a machine learning model configured to compute a probability of an additional edge for a dataset that includes a plurality of nodes and a plurality of edges based on a first nonnegative matrix representing a homophilous cluster affinity and a second nonnegative matrix representing a heterophilous cluster affinity, wherein the machine learning model represents a homophilous cluster and a heterophilous cluster of the plurality of nodes; and a data augmentation component configured to generate an augmented dataset including the plurality of nodes, the plurality of edges, and the additional edge.

### BRIEF DESCRIPTION OF THE DRAWINGS

FIG. 1 shows an example of a data augmentation system according to embodiments of the present disclosure.

FIG. 2 shows an example of a data augmentation apparatus according to embodiments of the present disclosure.

FIG. 3 shows an example of a machine learning model according to embodiments of the present disclosure.

FIG. 4 shows an example of a data augmentation method according to embodiments of the present disclosure.

FIG. 5 shows an example of a data completion process according to embodiments of the present disclosure.

FIG. 6 shows an example of affinity clustering according to embodiments of the present disclosure.

FIG. 7 shows an example of a method for data augmentation according to embodiments of the present disclosure.

FIG. 8 shows an example of a method for computing a probability of an additional edge according to embodiments of the present disclosure.

FIG. 9 shows an example of a method for training a machine learning model according to embodiments of the present disclosure.

FIG. 10 shows an example of a regularization process according to embodiments of the present disclosure.

FIG. 11 shows an example of synthetic graph reconstruction according to embodiments of the present disclosure.

FIG. 12 shows an example of synthetic graph decomposition according to embodiments of the present disclosure.

FIG. 13 shows an example of fitting a constrained model according to embodiments of the present disclosure.

FIG. 14 shows an example of converting logistic principal component analysis (LPCA) factors according to embodiments of the present disclosure.

### DETAILED DESCRIPTION

The present disclosure describes systems and methods for data augmentation. Embodiments of the disclosure include a data augmentation apparatus configured to compute a probability of a new edge based on a dataset. The data augmentation apparatus includes a generative graph model configured to represent heterophily and overlapping clusters based on nonnegative matrix factorization. The graph model outputs probabilities of additional links or edges which are interpretable in terms of the clusters (e.g., communities) it detects. According to some embodiments, a training component performs initialization of the nonnegative factors using arbitrary real factors generated by logistic component analysis.

In some cases, a machine learning model is trained based on a dataset that has missing data points (i.e., values). The rows that have missing values are often excluded from training the model, for example, a visualization application (e.g., a dashboard) generates visualizations from a subset of attributes in user dataset of interest (e.g., scatterplot) using exclusively the rows or data points with no missing values. However, such rows with complete values are biased, and non-representative of the data points in the user dataset. Accordingly, without interpretable data augmentation, the trained machine learning model produces visualizations with poor predictive performance, bias, incorrect analysis, and conclusions.

Embodiments of the present disclosure include a data augmentation apparatus configured to train a graph model and use the trained graph model to augment a dataset with missing values to obtain an augmented dataset. The data augmentation apparatus uses the affinity of a node towards a community (i.e., a homophilous cluster or a heterophilous cluster) and the effect of participation of the node in the community to capture community affinities of the nodes. The affinities then increase or decrease the probability value of a link. For example, two nodes participating in a same community increases the probability of a link (e.g., a link between the two nodes). Two nodes participating in a different community decreases the probability of a link (e.g., a link between the two nodes). In some cases, a training component of the data augmentation apparatus is configured to minimize a loss function based on link predictions over the pairs of nodes in a graph. In some cases, phrases “communities” and “clusters” may be used interchangeably.

Some embodiments of the present disclosure include a generative graph model that is able to capture homophily and heterophily in the data. Heterophilous structure or heterophily refers to a graph structure where links are present between dissimilar nodes, such as interaction between men and women. For example, the model produces nonnegative node representations which provide for link predictions to be interpreted in terms of node clusters and outputs edge probabilities. On the other hand, homophilous structure or homophily refers to clustered nodes that are likely to be connected or linking between similar nodes. By integrating homophily, the graph model measures community affinities of the nodes and the affinities with the increase or decrease of the probability of a link between the nodes. The generative graph model is explainable (interpretable) while being naturally expressive enough to capture both heterophily and homophily. The data augmentation apparatus can capture community overlap and heterophily in the data and provides intuitions between different communities at a high level. This way, the graph model is generalizable to model real-world data where heterophily is commonly present.

In some embodiments, the data augmentation apparatus receives a dataset that includes nodes and edges that form connections between nodes. A machine learning model calculates the probability of an additional edge based on the dataset received that represents homophilous and heterophilous clusters. A training component of the data augmentation apparatus updates the parameters of the machine learning model based on the predicted probability of the edge. The training component then generates an augmented dataset including the nodes, edges, and the additional edge, thus filling connections between attributes and missing data points or cell values in the dataset.

In some embodiments of the present disclosure, the data augmentation apparatus computes the nonnegative matrices representing homophilous or heterophilous cluster affinities. The training component is configured to fit a logistic components analysis (LCA) model, yielding unconstrained factors followed by processing the unconstrained factors into nonnegative initializations. Further, the model computes products of the non-negative matrices with the corresponding transpose matrices followed by difference of the products to obtain a symmetric matrix. The difference is trained to minimize the cross-entropy loss of the link predictions over the pair of nodes. Regularization of the factors is performed subject to the nonnegativity of the node representations. In some examples, regularization methods are applied to the non-negative representations followed by normalization and ranking (i.e., ranking the non-negative representations based on the normalization). Thus, the machine learning model computes the edge probabilities that indicate the probability of a link between nodes.

Embodiments of the present disclosure include a graph model configured to represent heterophily and overlapping communities based on a dataset. The graph model is based on nonnegative matrix factorization and the graph model outputs link probabilities which are interpretable in terms of the communities the graph model detects. The graph model performs initialization of the nonnegative factors using arbitrary real factors generated by logistic principal component analysis (LPCA). The data augmentation apparatus can represent a natural class of graphs with a small number of communities which exhibits heterophily and overlapping communities. Example experiments and evaluation demonstrate that apparatus, methods, and algorithms described in the present disclosure are competitive in dealing with real-world graphs in areas such as representing a network, doing interpretable link prediction, and detecting communities that align with ground-truth.

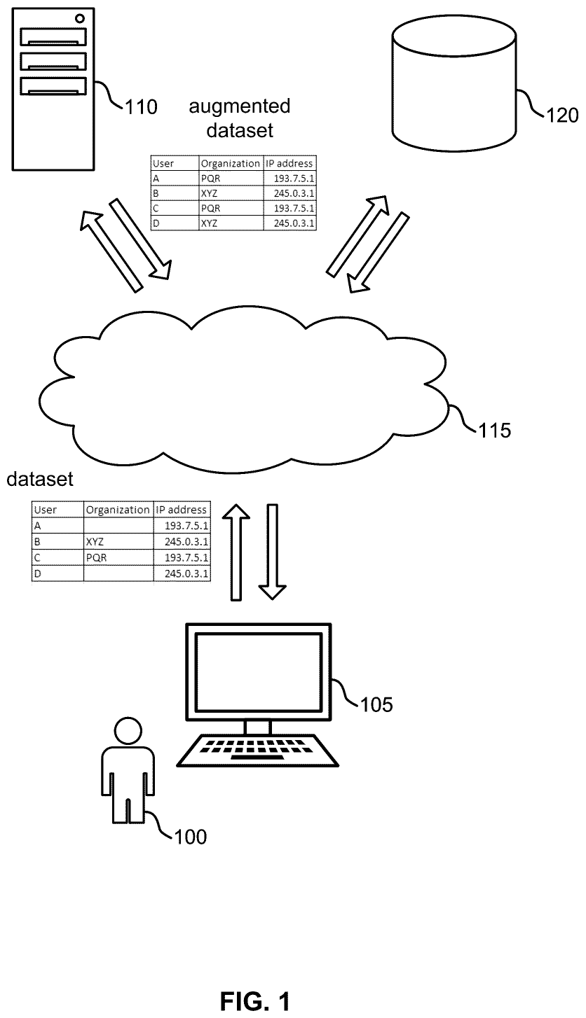

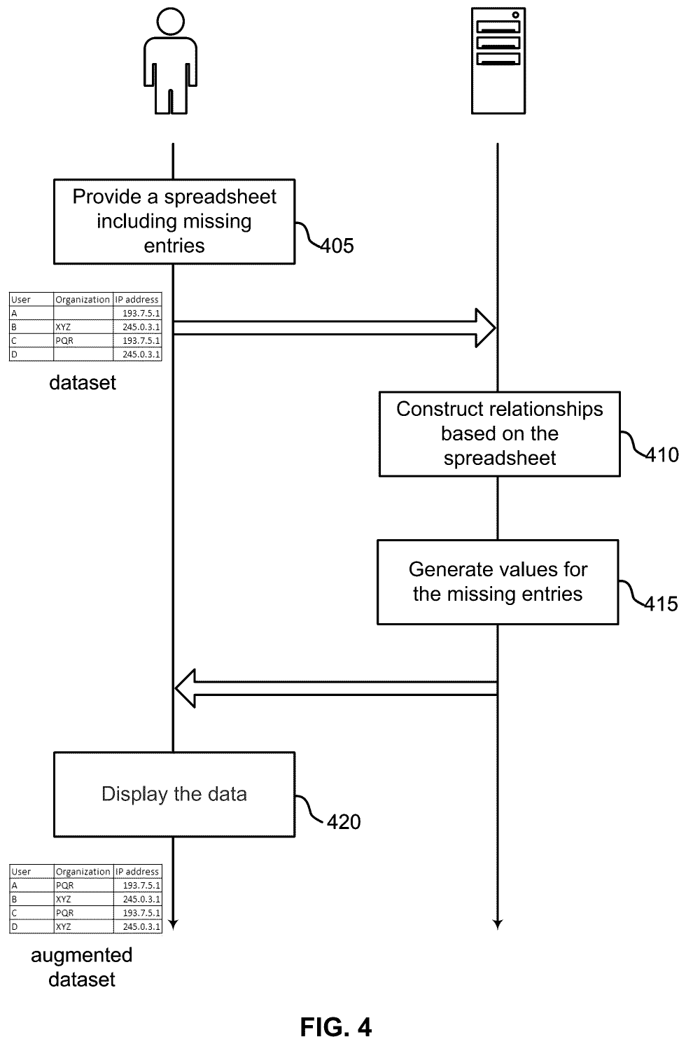

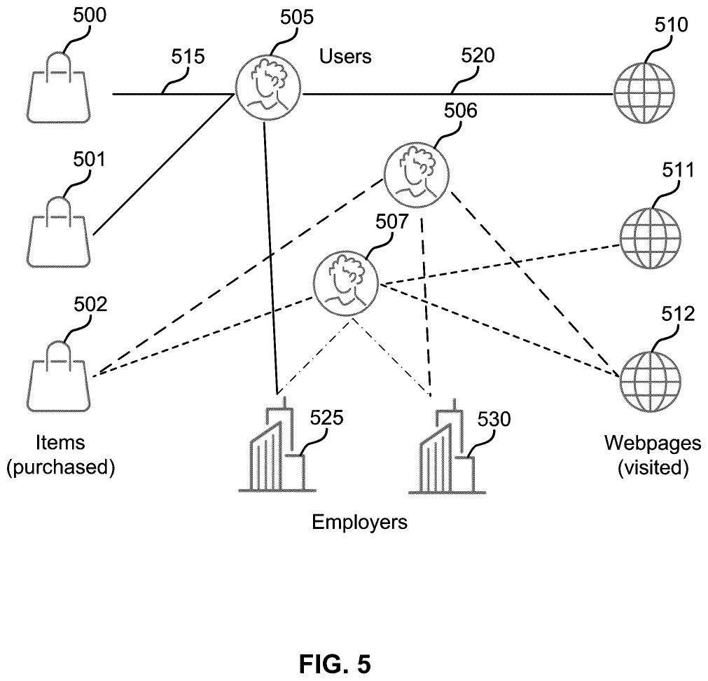

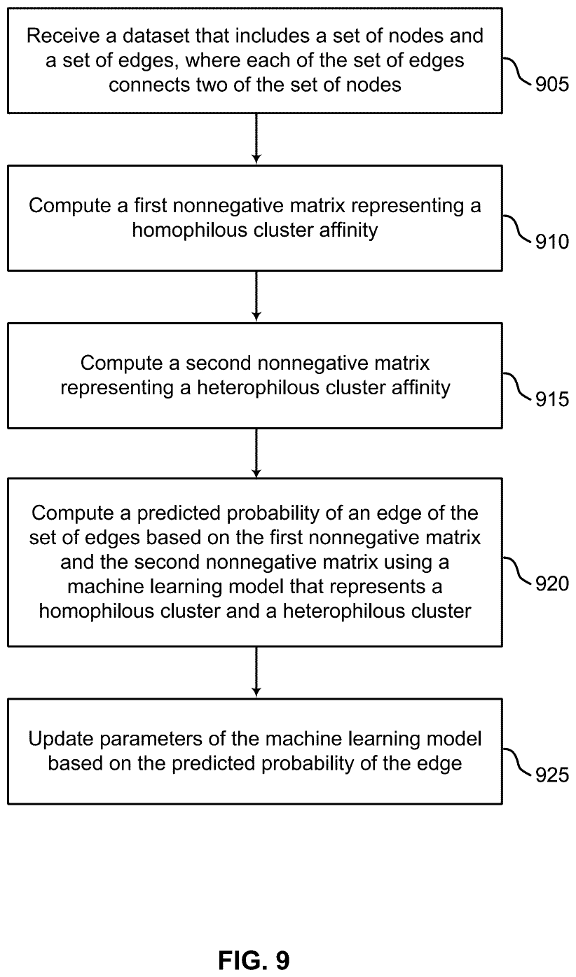

Embodiments of the disclosure may be used in the context of data augmentation. For example, a data augmentation system includes a graph based generative model that receives a dataset (e.g., tabular dataset or any user uploaded data) including nodes and edges and generates an augmented dataset that can be used to predict missing cell values. In some examples, the graph model computes community affinities of the nodes and the affinities with the increase or decrease of the probability of a link between the nodes. The data augmentation system can capture community overlap and heterophily in the dataset and provides information between different communities. An example application, according to some embodiments, is provided with reference to FIG. 4. Details regarding the architecture of an example data augmentation apparatus are provided with reference to FIGS. 1-3. Example processes for data augmentation are provided with reference to FIGS. 5-8. Example training processes are described with reference to FIGS. 9-14.

### Network Architecture

In FIGS. 1-3, an apparatus and method for data augmentation are described. One or more embodiments of the apparatus and method include a processor; a memory including instructions executable by the processor; a machine learning model configured to compute a probability of an additional edge for a dataset that includes a plurality of nodes and a plurality of edges based on a first nonnegative matrix representing a homophilous cluster affinity and a second nonnegative matrix representing a heterophilous cluster affinity, wherein the machine learning model represents a homophilous cluster and a heterophilous cluster of the plurality of nodes; and a data augmentation component configured to generate an augmented dataset including the plurality of nodes, the plurality of edges, and the additional edge.

Some examples of the apparatus and method further include a cluster affinity component configured to compute a cluster affinity matrix based on the first nonnegative matrix and the second nonnegative matrix, wherein the machine learning model includes the cluster affinity matrix. Some examples of the apparatus and method further include a training component configured to update parameters of the machine learning model based on the probability of the additional edge. In some embodiments, the training component comprises a logistic principal components analysis (LPCA) model.

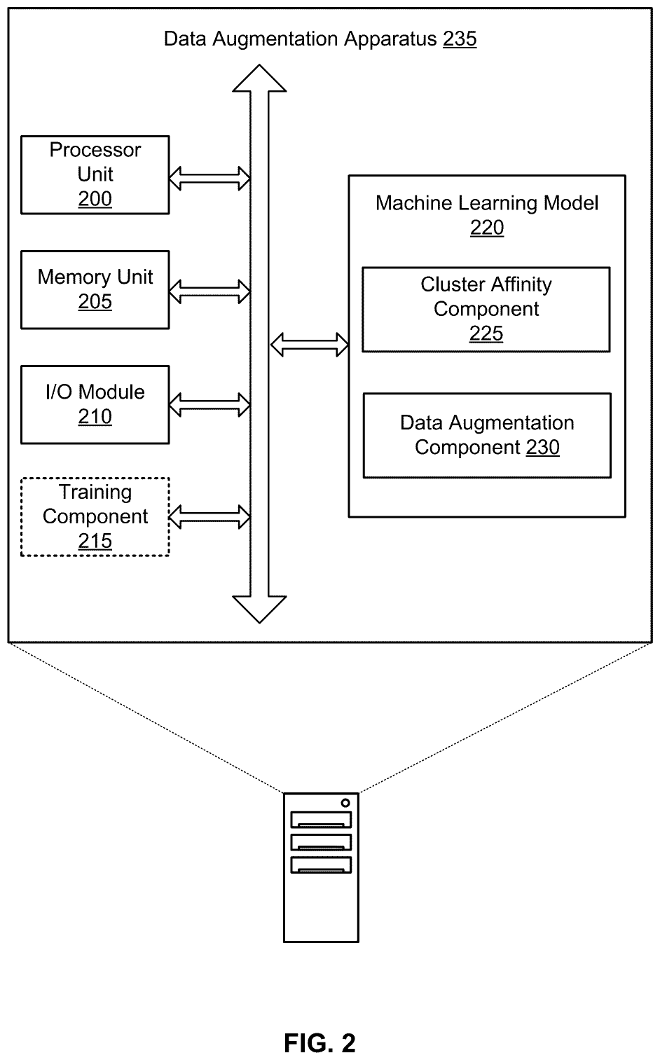

FIG. 1 shows an example of a data augmentation system according to embodiments of the present disclosure. The example shown includes user 100, user device 105, data augmentation apparatus 110, cloud 115, and database 120. Data augmentation apparatus 110 is an example of, or includes embodiments of, the corresponding element described with reference to FIGS. 2, 3, and 5.

As an example shown in FIG. 1, user 100 uploads a dataset (e.g., a spreadsheet) to data augmentation apparatus 110 via e.g., user device 105 and cloud 115. The dataset includes a set of attributes or columns. Each row of the dataset represents an entry. Each column of the dataset represents an attribute associated with the entry. In some cases, data augmentation apparatus 110 is configured to output an augmented dataset using explainable dataset completion. Data augmentation apparatus 110 predicts links between existing data to form interpretable representations of data. Data augmentation apparatus 110 captures a homophilous cluster affinity (e.g., link between similar nodes) and a heterophilous cluster affinity (e.g., link between dissimilar nodes) based on the dataset.

In the above example, the original dataset has missing cell values, i.e., an organization attribute corresponding to user A and user D. Data augmentation apparatus 110 can predict the missing cell values to obtain an augmented dataset. Users that have the same IP address have an increased chance of belonging to a same organization. The augmented dataset is returned to user 100 via cloud 115 and user device 105. User 100 may then utilize the augmented dataset for improved visualizations, analysis, model training, etc.

User interface may enable user 100 to interact with a device. In some embodiments, a user interface may include an audio device, such as an external speaker system, an external display device such as a display screen, or an input device (e.g., remote control device interfaced with the user interface directly or through an I/O controller module). In some cases, a user interface may be a graphical user interface (GUI).

User device 105 may be a personal computer, laptop computer, mainframe computer, palmtop computer, personal assistant, mobile device, or any other suitable processing apparatus. In some examples, user device 105 includes software that incorporates a data augmentation application. The data augmentation application may either include or communicate with data augmentation apparatus 110. In some examples, the data augmentation application on user device 105 may include functions of data augmentation apparatus 110.

Data augmentation apparatus 110 includes a computer implemented network comprising a machine learning model that further includes a cluster affinity component and a data augmentation component. Data augmentation apparatus 110 may also include a processor unit, a memory unit, an I/O module, and a training component. Additionally, data augmentation apparatus 110 can communicate with database 120 via cloud 115. In some cases, the architecture of the data augmentation network is also referred to as a network or a network model. Further detail regarding the architecture of data augmentation apparatus 110 is provided with reference to FIGS. 1-3. Further detail regarding the operation of data augmentation apparatus 110 is provided with reference to FIGS. 4-8.

In some cases, data augmentation apparatus 110 is implemented on a server. A server provides one or more functions to users linked by way of one or more of the various networks. In some cases, the server includes a single microprocessor board, which includes a microprocessor responsible for controlling all embodiments of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with database controller. In other cases, database controller may operate automatically without user interaction.

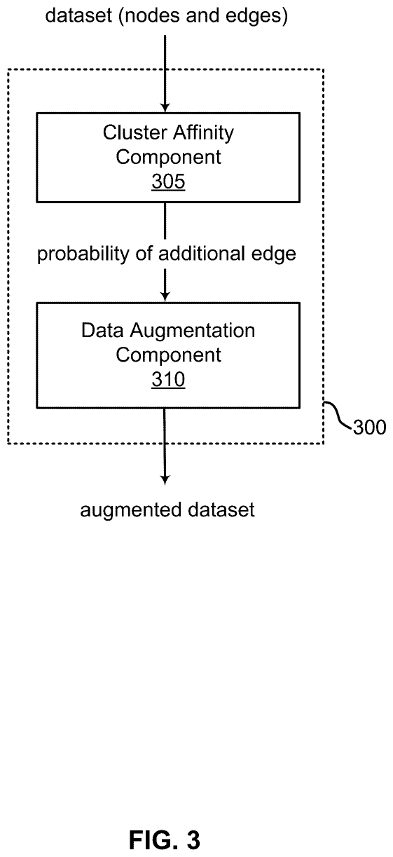

FIG. 2 shows an example of a data augmentation apparatus according to embodiments of the present disclosure. The example shown includes processor unit 200, memory unit 205, I/O module 210, training component 215, and machine learning model 220. In one embodiment, machine learning model 220 includes cluster affinity component 225 and data augmentation component 230. Data augmentation apparatus 235 is an example of, or includes embodiments of, the corresponding element described with reference to FIG. 1. According to an embodiment, data augmentation apparatus 235 includes processor unit 200, memory unit 205, I/O module 210, training component 215, and machine learning model 220. Machine learning model 220 is an example of, or includes embodiments of, the corresponding element described with reference to FIG. 3.

Processor unit 200 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 200 is configured to operate a memory array using a memory controller. In other cases, a memory controller is integrated into processor unit 200. In some cases, processor unit 200 is configured to execute computer-readable instructions stored in a memory to perform various functions. In some embodiments, processor unit 200 includes special purpose components for modem processing, baseband processing, digital signal processing, or transmission processing.

Examples of memory unit 205 include random access memory (RAM), read-only memory (ROM), or a hard disk. Examples of memory unit 205 include solid state memory and a hard disk drive. In some examples, memory unit 205 is used to store computer-readable, computer-executable software including instructions that, when executed, cause a processor to perform various functions described herein. In some cases, memory unit 205 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory unit 205 store information in the form of a logical state.

I/O module 210 includes an I/O controller. The I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via I/O controller or via hardware components controlled by an I/O controller.

In some examples, I/O module 210 includes a user interface. A user interface may enable a user to interact with a device. In some embodiments, the user interface may include an audio device, such as an external speaker system, an external display device such as a display screen, or an input device (e.g., remote control device interfaced with the user interface directly or through an I/O controller module). In some cases, a user interface may be a graphical user interface (GUI). In some examples, a communication interface operates at the boundary between communicating entities and the channel and may also record and process communications. Communication interface is provided herein to enable a processing system coupled to a transceiver (e.g., a transmitter and/or a receiver). In some examples, the transceiver is configured to transmit (or send) and receive signals for a communications device via an antenna.

According to an embodiment, training component 215 receives a dataset that includes a set of nodes and a set of edges, where each of the set of edges connects two of the set of nodes. In some examples, training component 215 updates parameters of machine learning model 220 based on the predicted probability of the edge.

According to some embodiments, training component 215 selects a regularization term. In some examples, training component 215 applies the regularization term to the first nonnegative matrix to obtain a regularized first nonnegative matrix. Furthermore, training component 215 applies the regularization term to the second nonnegative matrix to obtain a regularized second nonnegative matrix, where the parameters of machine learning model 220 are updated based on the regularized first nonnegative matrix and the regularized second nonnegative matrix.

According to some embodiments, training component 215 computes an L2 norm of a set of columns of the first nonnegative matrix. Training component 215 ranks the set of columns based on the L2 norm, where the predicted probability of the edge is computed based on the ranking. In some examples, training component 215 computes an L2 norm of a set of columns of the second nonnegative matrix. Training component 215 ranks the set of columns of the second nonnegative matrix based on the L2 norm, where the predicted probability of the edge is computed based on the ranking.

According to some embodiments, training component 215 is configured to update parameters of machine learning model 220 based on the probability of the additional edge. In some embodiments, training component 215 includes a logistic principal components analysis (LPCA) model. In some examples, training component 215 is part of another apparatus other than data augmentation apparatus 235.

According to some embodiments of the present disclosure, data augmentation apparatus 235 includes a computer implemented artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted.

Accordingly, during the training process, the parameters and weights of machine learning model 220 are adjusted to increase the accuracy of the result (i.e., by attempting to minimize a loss function which corresponds to the difference between the current result and the target result at a time of training). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to an embodiment, machine learning model 220 receives a dataset that includes a set of nodes and a set of edges, where each of the set of edges connects two of the set of nodes. In some examples, machine learning model 220 computes a first nonnegative matrix representing a homophilous cluster affinity. Machine learning model 220 computes a second nonnegative matrix representing a heterophilous cluster affinity. Furthermore, machine learning model 220 computes a probability of an additional edge based on the dataset that represents a homophilous cluster and a heterophilous cluster based on the first nonnegative matrix and the second nonnegative matrix.

According to some embodiments, machine learning model 220 adds the additional edge to the dataset to obtain the augmented dataset. In some examples, machine learning model 220 computes a first product of the first nonnegative matrix and a transpose of the first nonnegative matrix. Machine learning model 220 computes a second product of the second nonnegative matrix and a transpose of the second nonnegative matrix. Further, machine learning model 220 computes a difference between the first product and the second product to obtain a symmetric difference matrix. Machine learning model 220 applies a nonnegative nonlinear function to the symmetric difference matrix, where the probability of the additional edge is based on the nonnegative nonlinear function.

According to some embodiments, machine learning model 220 computes a first nonnegative matrix representing a homophilous cluster affinity. In some examples, machine learning model 220 computes a second nonnegative matrix representing a heterophilous cluster affinity. In some examples, machine learning model 220 computes a predicted probability of an edge of the set of edges based on the first nonnegative matrix and the second nonnegative matrix that represents a homophilous cluster and a heterophilous cluster.

In some examples, machine learning model 220 computes a first product of the first nonnegative matrix and a transpose of the first nonnegative matrix. Machine learning model 220 computes a second product of the second nonnegative matrix and a transpose of the second nonnegative matrix. Machine learning model 220 computes a difference between the first product and the second product to obtain a symmetric difference matrix. Machine learning model 220 applies a nonnegative nonlinear function to the symmetric difference matrix, where the predicted probability of the edge is based on the nonnegative nonlinear function.

According to some embodiments, machine learning model 220 is configured to compute a probability of an additional edge for a dataset that includes a plurality of nodes and a plurality of edges based on a first nonnegative matrix representing a homophilous cluster affinity and a second nonnegative matrix representing a heterophilous cluster affinity, wherein machine learning model 220 represents a homophilous cluster and a heterophilous cluster of the plurality of nodes.

In one embodiment, machine learning model 220 includes cluster affinity component 225 and data augmentation component 230. Machine learning model 220 is an example of, or includes embodiments of, the corresponding element described with reference to FIG. 3.

According to some embodiments, cluster affinity component 225 identifies a number of clusters, where a sum of a dimension of the first nonnegative matrix and a dimension of the second nonnegative matrix is equal to the number of clusters. In some examples, cluster affinity component 225 computes a first factor matrix and a second factor matrix, where the first factor matrix or the second factor matrix includes a negative value, and where the first nonnegative matrix and the second nonnegative matrix are computed based on the first factor matrix and the second factor matrix. Cluster affinity component 225 computes a cluster affinity matrix based on the first nonnegative matrix and the second nonnegative matrix, where the machine learning model 220 includes the cluster affinity matrix. Cluster affinity component 225 is an example of, or includes embodiments of, the corresponding element described with reference to FIG. 3.

According to an embodiment, data augmentation component 230 generates an augmented dataset including the set of nodes, the set of edges, and the additional edge. Data augmentation component 230 is an example of, or includes embodiments of, the corresponding element described with reference to FIG. 3.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

FIG. 3 shows an example of a machine learning model according to embodiments of the present disclosure. Machine learning model 300 is an example of, or includes embodiments of, the corresponding element described with reference to FIG. 2. The example shown includes machine learning model 300 and data augmentation component 310. In one embodiment, machine learning model 300 includes cluster affinity component 305. Cluster affinity component 305 and data augmentation component 310 are examples of, or include embodiments of, the corresponding element described with reference to FIG. 2.

According to an embodiment of the present disclosure, the machine learning model 300 is configured to extract nodes and edges from a received dataset to compute non-negative matrices representing cluster affinity. Further, the machine learning model 300 computes a probability of an additional edge based on the dataset representing homophilous and heterophilous clusters which is then input to data augmentation component 310.

As an example shown in FIG. 3, machine learning model 300 receives a dataset with missing data that includes a plurality of nodes and edges, where an edge can be defined as a connection between two of the plurality of nodes. Machine learning model 300 computes first and second nonnegative matrices representing homophilous and heterophilous cluster affinity based on the nodes and edges. Cluster affinity component 305 computes probability of an additional edge based on the first and second nonnegative matrices. Data augmentation component 310 generates an augmented dataset including the nodes, edges, and the additional edge that provides for an explainable dataset completion.

According to an embodiment, machine learning model 300 includes a factorization-based graph model that is sufficiently expressive to capture heterophily in the dataset. Machine learning model 300 produces nonnegative node representations which generate link predictions to be interpreted in terms of node clusters. Additionally, machine learning model 300 outputs edge probabilities and optimizes real-world graphs with gradient descent on a cross-entropy loss. In some cases, expressiveness of a machine learning model refers to the ability of the model to reconstruct a graph using a number of clusters that is linear in the maximum degree and the ability of the model to capture heterophily and homophily in the graph.

### Data Augmentation

In FIGS. 4-8, a method, apparatus, and non-transitory computer readable medium for data augmentation is described. One or more embodiments of the method, apparatus, and non-transitory computer readable medium include receiving a dataset that includes a plurality of nodes and a plurality of edges, wherein each of the plurality of edges connects two of the plurality of nodes; computing a first nonnegative matrix representing a homophilous cluster affinity; computing a second nonnegative matrix representing a heterophilous cluster affinity; computing a probability of an additional edge based on the dataset using a machine learning model that represents a homophilous cluster and a heterophilous cluster based on the first nonnegative matrix and the second nonnegative matrix; and generating an augmented dataset including the plurality of nodes, the plurality of edges, and the additional edge.

Some examples of the method, apparatus, and non-transitory computer readable medium further include providing a content item to a user based on the augmented dataset, wherein the user and the content item are represented by the plurality of nodes. Some examples of the method, apparatus, and non-transitory computer readable medium further include adding the additional edge to the dataset to obtain the augmented dataset.

Some examples of the method, apparatus, and non-transitory computer readable medium further include computing a first product of the first nonnegative matrix and a transpose of the first nonnegative matrix. Some examples further include computing a second product of the second nonnegative matrix and a transpose of the second nonnegative matrix. Some examples further include computing a difference between the first product and the second product to obtain a symmetric difference matrix. Some examples further include applying a nonnegative nonlinear function to the symmetric difference matrix, wherein the probability of the additional edge is based on the nonnegative nonlinear function.

Some examples of the method, apparatus, and non-transitory computer readable medium further include identifying a number of clusters, wherein a sum of a dimension of the first nonnegative matrix and a dimension of the second nonnegative matrix is equal to the number of clusters.

Some examples of the method, apparatus, and non-transitory computer readable medium further include computing a first factor matrix and a second factor matrix, wherein the first factor matrix or the second factor matrix includes a negative value, and wherein the first nonnegative matrix and the second nonnegative matrix are computed based on the first factor matrix and the second factor matrix.

Some examples of the method, apparatus, and non-transitory computer readable medium further include computing a cluster affinity matrix based on the first nonnegative matrix and the second nonnegative matrix, wherein the machine learning model includes the cluster affinity matrix.

FIG. 4 shows an example of a method for data augmentation according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with embodiments of the present disclosure. In some cases, the operations described herein are composed of various substeps, or are performed in conjunction with other operations.

At operation 405, the user provides a spreadsheet (e.g., a dataset) that includes missing entries to the system. In some cases, the operations of this step refer to, or may be performed by, a user as described with reference to FIGS. 1, 5, and 6. For example, the spreadsheet includes a set of columns (e.g., attributes). Some cells of the spreadsheet have missing cell values. In this example, the organization attribute corresponding to user A and user D is missing or unknown.

At operation 410, the system constructs relationships based on the spreadsheet (e.g., dataset). In some cases, the operations of this step refer to, or may be performed by, a data augmentation apparatus as described with reference to FIGS. 1 and 2. In some examples, the data augmentation apparatus detects homophilous and heterophilous structures in graphs. In some cases, a homophilous structure refers to a graph where links occur between similar nodes. A heterophilous structure refer to a graph where links occur between dissimilar nodes.

At operation 415, the system generates values for the missing entries based on the constructed relationships. In some cases, the operations of this step refer to, or may be performed by, a data augmentation apparatus as described with reference to FIGS. 1 and 2. In some examples, the data augmentation apparatus computes a probability of an additional edge based on the dataset (e.g., the spreadsheet) and adds the additional edge to the dataset to obtain an augmented dataset. For example, the augmented spreadsheet includes missing values. In this example, the data augmentation apparatus identifies the organization attribute corresponding to user A and user D based on IP addresses. Users with similar IP addresses are likely to work for the same organization (e.g., increased probability to belong to the same organization).

At operation 420, the system displays the data, for example as an augmented spreadsheet. In some cases, the operations of this step refer to, or may be performed by, a data augmentation apparatus as described with reference to FIGS. 1 and 2. For example, the user can use the augmented dataset with filled cells for improved visualizations, analysis, model training, etc. Accordingly, the augmented spreadsheet has improved predictive performance and generalizability with low bias.

FIG. 5 shows an example of data completion process according to embodiments of the present disclosure. The example shown includes first content item 500, second content item 501, third content item 502, first user 505, second user 506, third user 507, first webpage 510, second webpage 511, third webpage 512, first edge 515, second edge 520, first employer 525, and second employer 530. Machine learning model 220 shown in FIG. 2 computes the probability of an edge between two nodes in a dataset. For example, an edge may be formed between two nodes, e.g., between first content item 500 and first user 505, between first user 505 and first webpage 510.

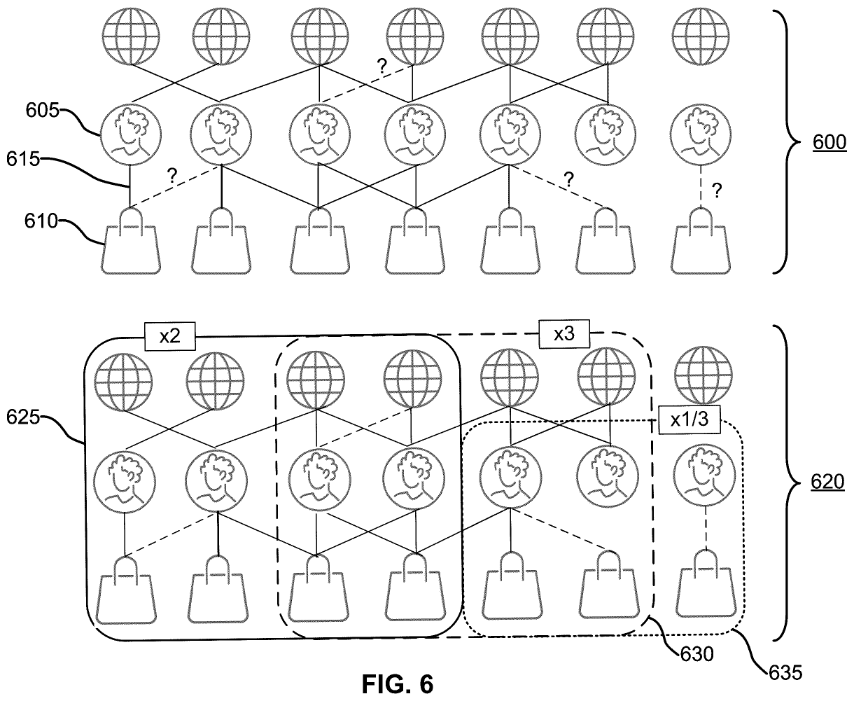

As shown in FIG. 5, first edge 515 connects first content item 500 and first user 505. First content item 500 is an example of, or includes embodiments of, the corresponding element described with reference to FIG. 6. First user 505 is an example of, or includes embodiments of, the corresponding element described with reference to FIG. 6. According to an embodiment, machine learning model 220 computes a probability of an edge existing between a pair of nodes when link between the pair of nodes is unknown.

As an example shown in FIG. 5, machine learning model 220 computes the

probability of second edge 520 between a pair of nodes. For example, second edge 520 connects first user 505 and first webpage 510. First webpage 510 is an example of, or includes embodiments of, the corresponding element described with reference to FIG. 6.

First user 505, second user 506, and third user 507 are in the center of FIG. 5, along with items they purchase, webpages they visit, and employers they are employed by. For example, first user 505 has purchased first content item 500, second content item 501. First user 505 has visited first webpage 510, and is employed by first employer 525. Second user 506 has purchased third content item 502. Second user 506 has visited third webpage 512. Second user 506 is employed by second employer 530.

Machine learning model 220 can predict which employer employs third user 507. Based on known links, machine learning model 220 predicts whether unknown links exist and assign probabilities to the existence of unknown links. A higher probability indicates there is such existence of a corresponding link. In this example, third user 507 is more similar to second user 506 than first user 505 in terms of the known links for the content items and webpages (second user 506 and third user 507 both like third content item 502 and third webpage 512). Thus, third user 507 is found to be distinct from first user 505. Accordingly, machine learning model 220 predicts a high probability for second employer 530, which employs second user 506, to be the employer of third user 507. Machine learning model 220 predicts a low probability for first employer 525 to be the employer of third user 507. As a result, machine learning model 220 can generate and fill in the missing data. In some cases, missing data can make visualizations impractical. When making a plot of a few attributes, a system may know those attributes for a small fraction of users. Hence, the plots are very sparse with points. According to an embodiment, machine learning model 220 can identify missing links between nodes or data points and generates new edges connecting the nodes.

FIG. 6 shows an example of affinity clustering according to embodiments of the present disclosure. The example shown includes graph 600, user 605, content item 610, edge 615, weighted graph 620, first cluster 625, second cluster 630, and third cluster 635. User 605 is an example of, or includes embodiments of, the corresponding element described with reference to FIG. 5. Content item 610 is an example of, or includes embodiments of, the corresponding element described with reference to FIG. 5. In this example, graph 600 includes a set of users, webpages, and products (e.g., content items). The solid lines indicate known links, representing that it is known that a user has visited a certain webpage or a user has purchased a certain item. The dashed lines indicate some unknown links of interest. Machine learning model 220 shown in FIG. 2 predicts whether these links exist, and their respective probability. The predictions for whether each link exists are initialized at a 50-50 baseline, i.e., 50% it exists, 50% it does not exist. Machine learning model 220 locates one or more clusters of these nodes, and being within these clusters would change the predicted odds of each link. An example of FIG. 6 includes three clusters, which are found altogether.

For example, machine learning model 220 may fit first cluster 625, which is dense with known links. Along with which nodes are in the cluster, machine learning model 220 learns a number, which indicates how being inside the cluster changes the predicted odds of a link existing. For example, machine learning model 220 doubles the predicted odds of the links inside first cluster 625. So for the two unknown links within the cluster, since the model starts with a baseline 1-to-1 odds of a link vs. no link, now machine learning model 220 predicts a 2-to-1 odds of these links existing.

Machine learning model 220 also learns second cluster 630, which is also dense with known edges. Machine learning model 220 triples the predicted odds of a link inside second cluster 630. These effects compound as follows. For the unknown link in the middle, at the intersection of first cluster 625 and second cluster 630, machine learning model 220 predicts a 6-to-1 odds of that link existing, that is, a user visiting that website. That is a 6 in 7 probability. To include context behind graph 600 and weighted graph 620, for example, second cluster 630 involves Canadian users, Canadian websites, and Canadian products. Links between these nodes are more likely to exist (i.e., the probability of link existence is high). Similarly, the nodes in first cluster 625, for example, represent sports fans, sports websites, sports products.

Certain communities may lower the odds of a link. For example, third cluster 635 on the bottom right seems relatively sparse. An odds factor is less than one, and it reduces the predicted odds of the links existing. For example, third cluster 635 represents vegetarian users and products with meat; vegetarian users are unlikely to buy meat-based products, so links between such users and products are unlikely to exist. In some cases, the thicker the dashed line, the greater the predicted probability of that link existing. Machine learning model 220 predicts higher probabilities where the known links are denser.

FIG. 6 shows results of affinity clustering to produce weighted graph 620 based on weights assigned to graph 600. As an example, first cluster 625 is assigned a weight equal to 2. Similarly, second cluster 630 is assigned a weight equal to 3 and third cluster 635 is assigned a weight equal to ⅓.

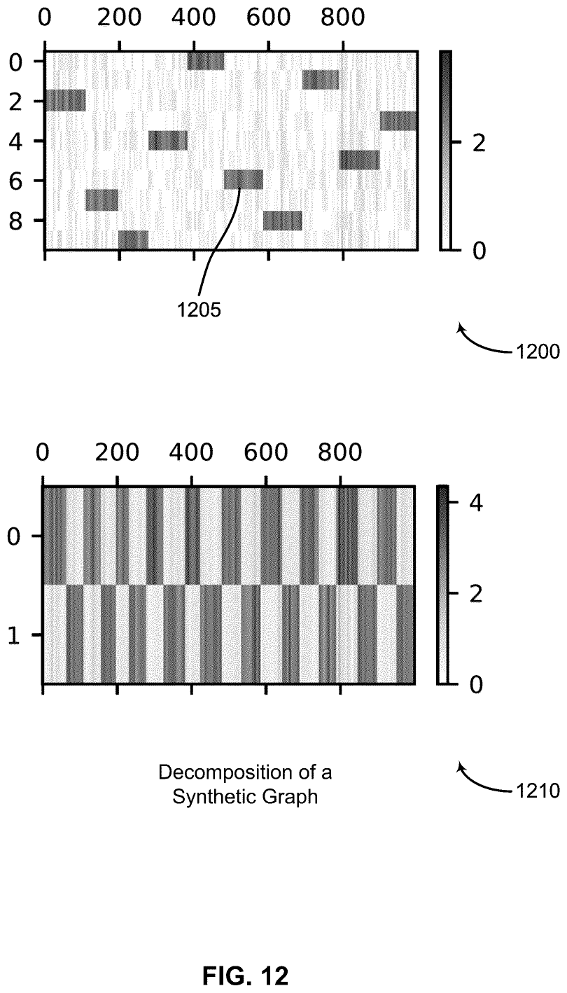

According to an embodiment, cluster affinity component 305 shown in FIG. 3 performs multi-label clustering or overlapping community detection. For example, the overlapping community detection provides for intersections of clusters or communities to be especially dense with edges that are observed in real-world networks. Graph decomposition provides for homophily and heterophily of the communities. An example of graph decomposition is described in FIG. 12 regarding synthetic graph decomposition. In some cases, homophily of communities refers to two nodes participating in the same community. Such two nodes increase the probability of a link between the two nodes. Heterophily of communities refer to two nodes participating in different communities with increased probability of a link.

Clustering and community detection on graph generative models suggests that the addition of a nonlinear linking function, e.g., softmax and logistic nonlinearities, can increase expressiveness of matrix factorization-based graph models. In some examples, overlapping communities can be determined, such as in link clustering, to achieve matching ground-truth communities.

According to an embodiment, the data augmentation apparatus 235 can represent a natural family of community overlap threshold (hereinafter COT) graphs, which exhibits homophily and heterophily, with small k and interpretably, where the value of k is based on number of communities. Community overlap threshold graph refers an unweighted, undirected graph whose edges are determined by an overlapping clustering and a thresholding integer t∈ [symbol] as follows: for each vertex i, there are two latent binary vectors bᵢ∈{0,1}^{k}^{_{b}} and cᵢ∈{0,1}^{k}^{_{c}}, and there is an edge between vertices i and j if and only if bᵢ×bⱼ−cᵢ×cⱼ≥t.

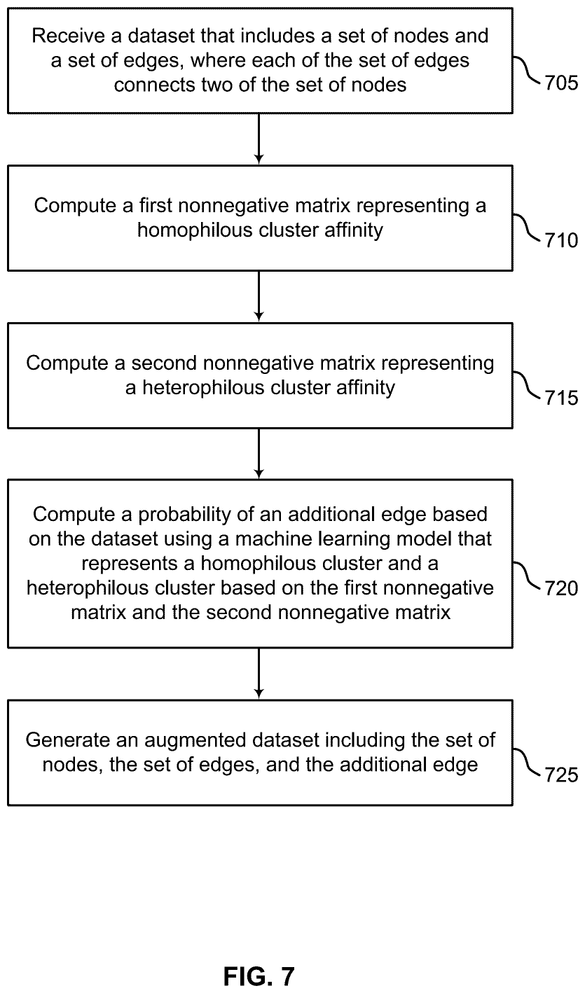

FIG. 7 shows an example of a method for data augmentation according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with embodiments of the present disclosure. In some cases, the operations described herein are composed of various substeps, or are performed in conjunction with other operations.

At operation 705, the system receives a dataset that includes a set of nodes and a set of edges, where each of the set of edges connects two of the set of nodes. In some cases, the operations of this step refer to, or may be performed by, a machine learning model as described with reference to FIGS. 2 and 3. For example, a graph model can form interpretable representations of nodes and produce edge probabilities in an interpretable manner. Similarly, dot product models can achieve interpretability by restricting the node embeddings to be nonnegative.

Machine learning model 220 as shown in FIG. 2 normalizes cluster assignments. In an embodiment, machine learning model 220 combines the homophilous and heterophilous cluster assignments. Machine learning model 220 depends on using a matrix V∈[0,1]^{n×k} and a diagonal matrix W∈ [symbol] ^{k×k}, where k=k_{B}+k_{C} is the total number of clusters. Let m_{B} and m_{C} be the vectors containing the maximums of each column of B and C. By setting

V=(B×diag(m_{B}⁻¹);C×diag(m_{C}⁻¹))

W=diag((+m_{B}²;−m_{C}²)) (1)

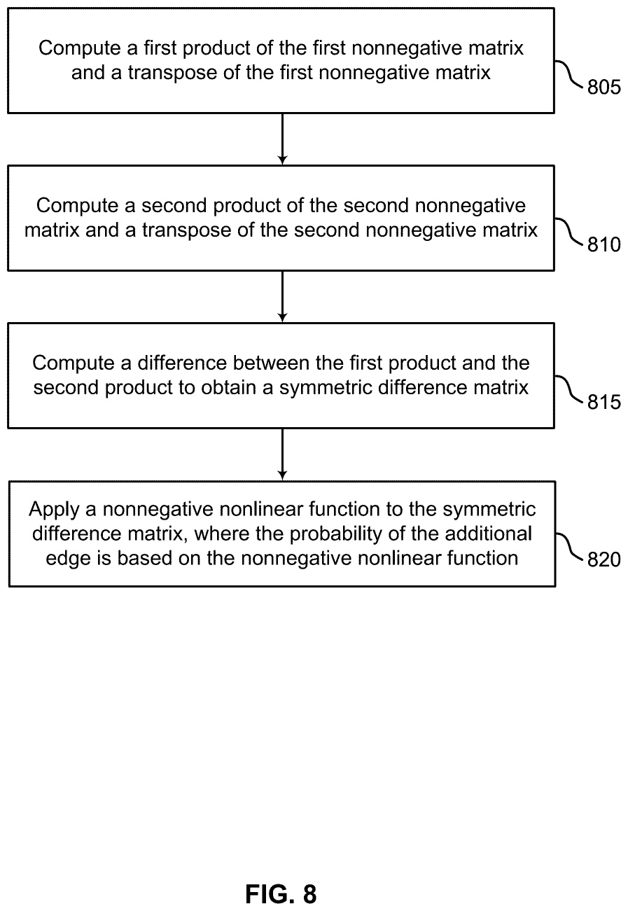

the constraint on V is satisfied, further VWV^{T}=BB^{T}−CC^{T}, so Ã:=σ(BB^{T}−CC^{T})=σ(VWV^{T}), where BB^{T} is the product of a first nonnegative matrix and a transpose of the first nonnegative matrix. CC^{T} is the product of a second nonnegative matrix and a transpose of the second nonnegative matrix. σ is a logistic function. Equation 1 is an example of, or includes embodiments of, corresponding elements described with reference to FIG. 8.

Here, if vᵢ∈[0,1]^{k} is the i-th row of matrix V, then vᵢ is the soft (normalized) assignment of node i to the k communities. The diagonal entries of W represent the strength of the homophily (if positive) or heterophily (if negative) of the communities. For each entry, Ã_{i,j}=σ(vᵢWvⱼ^{T}). In some cases, the two forms can be used interchangeably. In some examples, σ is used to denote a nonnegative nonlinear function.

One theorem relates to compact representation of COT graphs. Suppose A is the adjacency matrix of a COT graph on n nodes with latent vectors bᵢ∈{0,1}^{k}^{_{b}} and cᵢ∈{0,1}^{k}^{_{c}}, where i refers to a node and for i∈{1, 2, . . . , n}. Let k=k_{B}+k_{C}. Here k_{B}, k_{C} are the number of homophilous and heterophilous clusters, respectively. Then, for any ϵ>0, there exist V∈[0,1]^{n×(k+1)} and diagonal V∈ [symbol] ^{(k+1)×(k+1)} such that ∥σ(VWV^{T})−A∥_{F}<ϵ.

The data augmenting apparatus can process latent vectors into community factors B, C, and the thresholding integer can be handled with an extra community. W represents a cluster affinity matrix and diagonal entries of W represent the strength of the homophily (if positive) or heterophily (if negative) of the communities.

According to an embodiment, nodes in COT graphs share an edge if they co-participate in a number of homophilous communities and do not co-participate in a number of heterophilous communities. For example, in a graph, an edge occurs between two users if the two users are from the same city (e.g., a homophilous community) and have different genders (e.g., a heterophilous community).

At operation 710, the system computes a first nonnegative matrix representing a homophilous cluster affinity. In some cases, the operations of this step refer to, or may be performed by, a machine learning model as described with reference to FIGS. 2 and 3.

At operation 715, the system computes a second nonnegative matrix representing a heterophilous cluster affinity. In some cases, the operations of this step refer to, or may be performed by, a machine learning model as described with reference to FIGS. 2 and 3.

According to an embodiment of the present disclosure, machine learning model 220 (see FIG. 2) uses nonnegative factorization to decompose data into parts, i.e., a set of nodes of the network into clusters or communities. For example, each entry of the nonnegative embedding vector of a node represents the intensity with which the node participates in a community. The nonnegativity provides for the edge probabilities output by dot product models to be interpretable in terms of co-participation in communities. In some cases, the vectors may have a sum-to-one requirement, that is, the node is assigned a categorical distribution over communities.

At operation 720, the system computes a probability of an additional edge based on the dataset using a machine learning model that represents a homophilous cluster and a heterophilous cluster based on the first nonnegative matrix and the second nonnegative matrix. In some cases, the operations of this step refer to, or may be performed by, a machine learning model as described with reference to FIGS. 2 and 3. In some examples, machine learning model 220 as shown in FIG. 2 compresses information about graphs that include high dimensional objects. For example, machine learning model 220 can associate each node with a real-valued “embedding” vector and predict probability of a link between two nodes based on the corresponding embedding vectors.

According to an embodiment, machine learning model 220 extracts a set of nodes and edges from a dataset. For example, consider a set of undirected, unweighted graphs on n nodes, i.e., the set of graphs with symmetric adjacency matrices in {0,1}^{n×n}. An edge-independent generative model is used for such graphs. Given nonnegative parameter matrices B∈ [symbol] ₊^{n×k}^{_{B}} and C∈ [symbol] ₊^{n×k}^{_{C}}, the probability of an edge existing between nodes i and j is set to be the (i,j)-th entry of matrix Ã:

Ã:=σ(BB^{T}−CC^{T}) (2)

where BB^{T} is the product of a first nonnegative matrix and a transpose of the first nonnegative matrix. CC^{T} is the product of a second nonnegative matrix and a transpose of the second nonnegative matrix. σ is a logistic function. Here k_{B} and k_{C} are the number of homophilous and heterophilous clusters, respectively. For example, if bᵢ∈ [symbol] ₊^{k}^{_{B}} is the i-th row of matrix B, then bᵢ is the affinity of node i to each of the k_{B} homophilous communities. Similarly, cᵢ∈ [symbol] ₊^{k}^{_{C}} is the affinity of node i to the k_{C} heterophilous communities. For each pair of nodes i and j, Ã_{i,j}:=σ(bᵢbⱼ^{T}−cᵢcⱼ^{T}). Equation 2 is an example of, or includes embodiments of, corresponding elements described with reference to FIG. 8.

According to an embodiment, machine learning model 220 is configured for explainable dataset completion based on heterophilous and homophilous structures in a graph. A heterophilous structure includes links between dissimilar nodes. A homophilous structure includes links between similar nodes.

At operation 725, the system generates an augmented dataset including the set of nodes, the set of edges, and the additional edge. In some cases, the operations of this step refer to, or may be performed by, a data augmentation component as described with reference to FIGS. 2 and 3.

FIG. 8 shows an example of a method for computing a probability of an additional edge according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with embodiments of the present disclosure. In some cases, the operations described herein are composed of various substeps, or are performed in conjunction with other operations.

At operation 805, the system computes a first product of the first nonnegative matrix and a transpose of the first nonnegative matrix. In some cases, the operations of this step refer to, or may be performed by, a machine learning model as described with reference to FIGS. 2 and 3. In some examples, the first nonnegative matrix is B. The first product of the first nonnegative matrix and a transpose of the first nonnegative matrix is represented as BB^{T}.

At operation 810, the system computes a second product of the second nonnegative matrix and a transpose of the second nonnegative matrix. In some cases, the operations of this step refer to, or may be performed by, a machine learning model as described with reference to FIGS. 2 and 3. In some examples, the second nonnegative matrix is C. The second product of the second nonnegative matrix and a transpose of the second nonnegative matrix is represented as CC^{T}.

At operation 815, the system computes a difference between the first product and the second product to obtain a symmetric difference matrix. In some cases, the operations of this step refer to, or may be performed by, a machine learning model as described with reference to FIGS. 2 and 3. In some examples, the difference between the first product and the second product is represented as BB^{T}−CC^{T}.

According to an embodiment, the machine learning model processes factors X and Y into nonnegative factors B∈ [symbol] ₊^{n×k}^{_{B}} and C∈ [symbol] ₊^{n×k}^{_{C}} such that k_{B}+k_{C}=3k and

$${BB}^{T} - {CC}^{T} \approx \frac{1}{2} ( {XY}^{T} + {YX}^{T} ) \qquad ( 3 )$$

Here, BB^{T}−CC^{T} (i.e., the difference between the first product and the second product) represents symmetric matrices.

In some examples, let

$$L = \frac{1}{2} ( {XY}^{T} + {YX}^{T} ) .$$

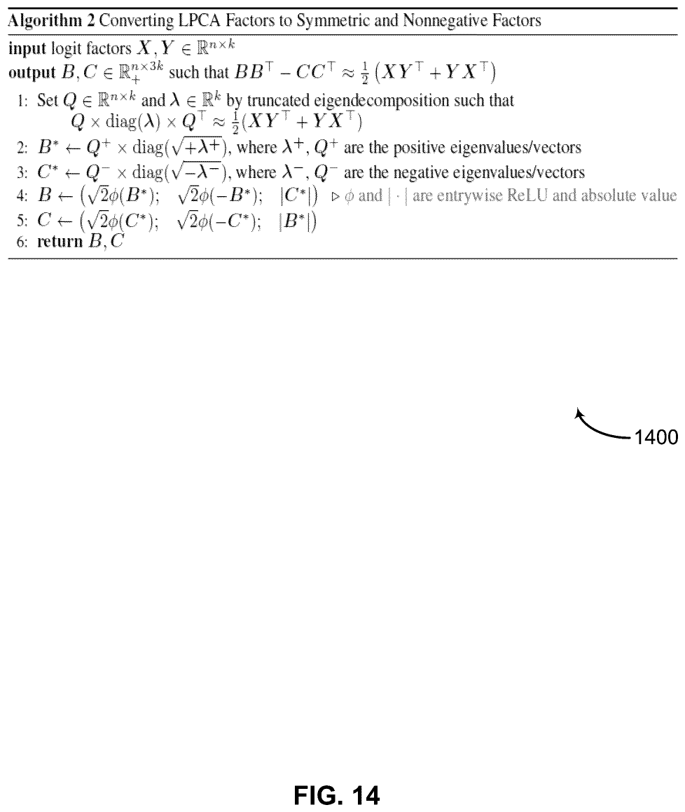

L is a symmetrization of XY^{T}. In some cases, if σ(XY^{T}) closely approximates the symmetric matrix A as desired, σ(L) also closely approximates the symmetric matrix A. Algorithm 1400 (with reference to FIG. 14) separates the logit matrix L into a sum and difference of rank-1 components via eigen-decomposition. Each of these components can be written as +vv^{T} or −vv^{T} with v∈ [symbol] ⁿ, where the sign depends on the sign of the eigenvalue. Each component is then separated into a sum and difference of three outer products of nonnegative vectors, via Lemma 1 described below.

In some examples, Lemma 1 states the following. Let ϕ: [symbol] → [symbol] denote the ReLU function, i.e., ϕ(z)=max{z,0}. For any vector v, vv^{T}=2ϕ(v)ϕ(v)^{T}+2ϕ(−v)ϕ(−v)^{T}−|v∥v|^{T}. The proof is described as follows: Take any v∈ [symbol] ^{k}. Then

$${vv}^{T} = ( ϕ ( v ) - ϕ ( - v ) ) \cdot ( {ϕ ( v )}^{T} - {ϕ ( - v )}^{T} ) = ϕ ( v ) {ϕ ( v )}^{T} + ϕ ( - v ) {ϕ ( - v )}^{T} - ϕ ( v ) {ϕ ( - v )}^{T} - ϕ ( - v ) {ϕ ( v )}^{T} = 2 ϕ ( v ) {ϕ ( v )}^{T} + 2 ϕ ( - v ) {ϕ ( - v )}^{T} - ( ϕ ( v ) + ϕ ( - v ) ) \cdot {( ϕ ( v ) + ϕ ( - v ) )}^{T} \\ {vv}^{T} = ( ϕ ( v ) - ϕ ( - v ) ) \cdot ( {ϕ ( v )}^{T} - {ϕ ( - v )}^{T} ) = ϕ ( v ) {ϕ ( v )}^{T} + ϕ ( - v ) {ϕ ( - v )}^{T} - ϕ ( v ) {ϕ ( - v )}^{T} - ϕ ( - v ) {ϕ ( v )}^{T} = 2 ϕ ( v ) {ϕ ( v )}^{T} + 2 ϕ ( - v ) {ϕ ( - v )}^{T} - ( ϕ ( v ) + ϕ ( - v ) ) \cdot {( ϕ ( v ) + ϕ ( - v ) )}^{T} \\ {vv}^{T} = ( ϕ ( v ) - ϕ ( - v ) ) \cdot ( {ϕ ( v )}^{T} - {ϕ ( - v )}^{T} ) = ϕ ( v ) {ϕ ( v )}^{T} + ϕ ( - v ) {ϕ ( - v )}^{T} - ϕ ( v ) {ϕ ( - v )}^{T} - ϕ ( - v ) {ϕ ( v )}^{T} = 2 ϕ ( v ) {ϕ ( v )}^{T} + 2 ϕ ( - v ) {ϕ ( - v )}^{T} - ( ϕ ( v ) + ϕ ( - v ) ) \cdot {( ϕ ( v ) + ϕ ( - v ) )}^{T}$$

$$= 2 ϕ ( v ) {ϕ ( v )}^{T} + 2 ϕ ( - v ) {ϕ ( - v )}^{T} - \vert v \vert {\vert v \vert}^{T}$$

The first step follows from v=ϕ(v)−ϕ(−v), and the last step follows from |v|=ϕ(v)+ϕ(−v). Algorithm 1400 as described in FIG. 14 is executed to compute the top-O(k) eigenvectors of

$$L = \frac{1}{2} ( {XY}^{T} + {YX}^{T} ) ,$$

which demonstrates O(nk) time matrix-vector multiplication. Thus, the eigenvectors can be computed efficiently using an iterative method.

In some examples, Theorem 1 relates to nonnegative factorization of rank-k matrices and Theorem 1 states the following. Given a symmetric rank-k matrix L∈ [symbol] ^{n×n} there exist nonnegative matrices B∈ [symbol] ₊^{n×k}^{_{B}} and C∈ [symbol] ₊^{n×k}^{_{C}} such that k_{B}+k_{C}=3k and BB^{T}+CC^{T}=L.

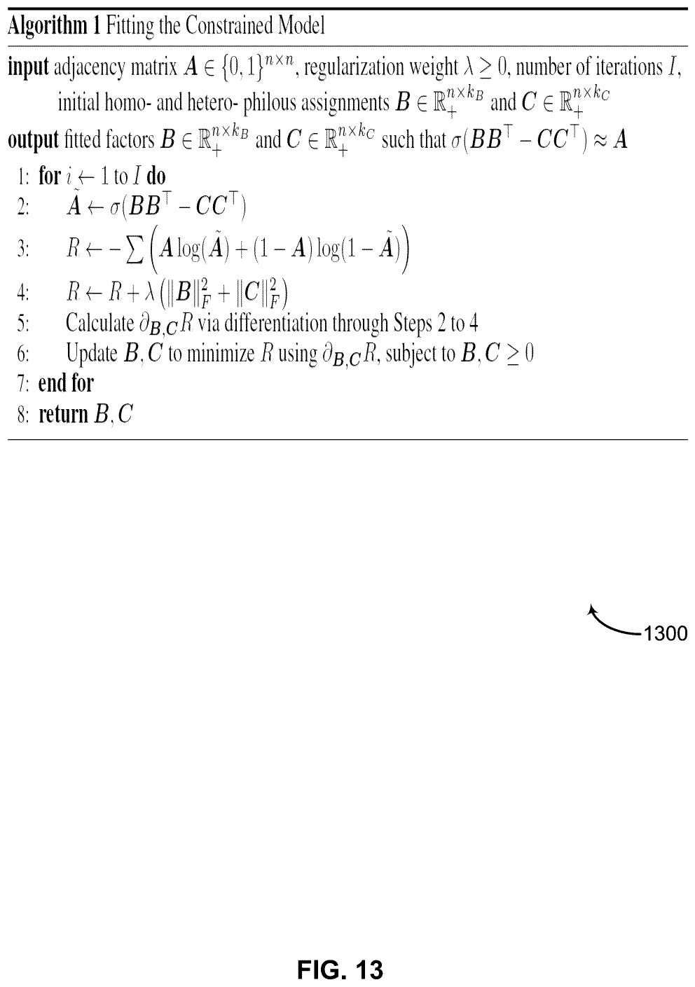

Theorem 1 and algorithm 1400 show that unconstrained factors X, Y for the LPCA model can be processed into symmetric and nonnegative factors B, C for machine learning model 220 (see FIG. 2) without any approximation error, at the cost of increasing the factorization rank. Therefore, for the initialization of the 3k communities generated by this step, the top k are kept which are most impactful on the edge logits, as ranked by the L₂ norms of the columns of B and C. Now B∈ [symbol] ₊^{n×k}^{_{B}} and C∈ [symbol] ₊^{n×k}^{_{C}} such that k_{B}+k_{C}=k. For initialization the k communities can then be optimized using algorithm 1300 as described in FIG. 13.

At operation 820, the system applies a nonnegative nonlinear function to the symmetric difference matrix, where the probability of the additional edge is based on the nonnegative nonlinear function. In some cases, the operations of this step refer to, or may be performed by, a machine learning model as described with reference to FIGS. 2 and 3.

According to an embodiment, the machine learning model combines the homophilous and heterophilous cluster assignments. The form uses a matrix V∈[0,1]^{n×k} and a diagonal matrix W∈ [symbol] ^{k×k}, where k=k_{B}+k_{C} is the total number of clusters. For example, let m_{B} and m_{C} be the vectors containing the maximums of each column of B and C. By setting

V=(B×diag(m_{B}⁻¹);C×diag(m_{C}⁻¹))

W=diag((+m_{B}²;−m_{C}²)) (4)

the constraint on V is satisfied. Furthermore, VWV^{T}=BB^{T}−CC^{T}, hence

Ã:=σ(BB^{T}−CC^{T})=σ(VWV^{T}) (5)

The edge probabilities output by the machine learning model may be interpreted as the following. There are bijections between probability p∈[0,1], odds

$$o = \frac{p}{1 - p} ∈ [ 0 , ∞ ) ,$$

and logit [symbol] =log(o)∈(−∞,+∞). The logit of the link probability between nodes i and j is vᵢ^{T}Wvⱼ, which is a summation of terms v_{ic}v_{jc}W_{cc} over communities c∈[k]. If the nodes fully participate in community c, that is, v_{ic}=v_{jc}=1, then the edge logit is changed by W_{cc} starting from a baseline of 0, or equivalently, the odds of an edge is multiplied by exp(W_{cc}) starting from a baseline odds of 1; if either of the nodes participates only partially in community c, then the change in logit and odds is accordingly prorated. Homophily and heterophily have a clear interpretation in the model: homophilous communities, which are expressed in B, are those with W_{cc}>0, where two nodes both participating in the community increases the odds of a link, whereas communities with W_{cc}<0, which are expressed in C, are heterophilous communities, and co-participation decreases the odds of a link.

### Training and Evaluation

In FIGS. 9-14, a method, apparatus, and non-transitory computer readable medium for data augmentation are described. One or more embodiments of the method, apparatus, and non-transitory computer readable medium include receiving a dataset that includes a plurality of nodes and a plurality of edges, wherein each of the plurality of edges connects two of the plurality of nodes; computing a first nonnegative matrix representing a homophilous cluster affinity; computing a second nonnegative matrix representing a heterophilous cluster affinity; computing a predicted probability of an edge of the plurality of edges based on the first nonnegative matrix and the second nonnegative matrix using a machine learning model that represents a homophilous cluster and a heterophilous cluster; and updating parameters of the machine learning model based on the predicted probability of the edge.

Some examples of the method, apparatus, and non-transitory computer readable medium further include training an additional edge to the dataset to obtain an augmented dataset.

Some examples of the method, apparatus, and non-transitory computer readable medium further include computing a first product of the first nonnegative matrix and a transpose of the first nonnegative matrix. Some examples further include computing a second product of the second nonnegative matrix and a transpose of the second nonnegative matrix. Some examples further include computing a difference between the first product and the second product to obtain a symmetric difference matrix. Some examples further include applying a nonnegative nonlinear function to the symmetric difference matrix, wherein the predicted probability of the edge is based on the nonnegative nonlinear function.

Some examples of the method, apparatus, and non-transitory computer readable medium further include identifying a number of clusters, wherein a sum of a dimension of the first nonnegative matrix and the second nonnegative matrix is equal to the number of clusters.

Some examples of the method, apparatus, and non-transitory computer readable medium further include computing a first factor matrix and a second factor matrix, wherein the first factor matrix or the second factor matrix includes a negative value, and wherein the first nonnegative matrix and the second nonnegative matrix are computed based on the first factor matrix and the second factor matrix.

Some examples of the method, apparatus, and non-transitory computer readable medium further include computing a cluster affinity matrix based on the first nonnegative matrix and the second nonnegative matrix, wherein the machine learning model includes the cluster affinity matrix.

Some examples of the method, apparatus, and non-transitory computer readable medium further include selecting a regularization term. Some examples further include applying the regularization term to the first nonnegative matrix to obtain a regularized first nonnegative matrix. Some examples further include applying the regularization term to the second nonnegative matrix to obtain a regularized second nonnegative matrix, wherein the parameters of the machine learning model are updated based on the regularized first nonnegative matrix and the regularized second nonnegative matrix.

Some examples of the method, apparatus, and non-transitory computer readable medium further include computing an L2 norm of a plurality of columns of the first nonnegative matrix. Some examples further include ranking the plurality of columns based on the L2 norm, wherein the predicted probability of the edge is computed based on the ranking.

Some examples of the method, apparatus, and non-transitory computer readable medium further include computing an L2 norm of a plurality of columns of the second nonnegative matrix. Some examples further include ranking the plurality of columns of the second nonnegative matrix based on the L2 norm, wherein the predicted probability of the edge is computed based on the ranking.

FIG. 9 shows an example of a method 900 for training a machine learning model according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with embodiments of the present disclosure. In some cases, the operations described herein are composed of various substeps, or are performed in conjunction with other operations.

At operation 905, the system receives a dataset that includes a set of nodes and a set of edges, where each of the set of edges connects two of the set of nodes. In some cases, the operations of this step refer to, or may be performed by, a training component as described with reference to FIG. 2.

At operation 910, the system computes a first nonnegative matrix representing a homophilous cluster affinity. In some cases, the operations of this step refer to, or may be performed by, a machine learning model as described with reference to FIGS. 2 and 3. In some examples, the first nonnegative matrix is denoted as B.

At operation 915, the system computes a second nonnegative matrix representing a heterophilous cluster affinity. In some cases, the operations of this step refer to, or may be performed by, a machine learning model as described with reference to FIGS. 2 and 3. In some examples, the second nonnegative matrix is denoted as C.

According to an embodiment of the present disclosure, machine learning model 220 (shown in FIG. 2) uses nonnegative factorization to decompose data into parts, i.e., set of nodes of the network into clusters or communities. Particularly, each entry of the nonnegative embedding vector of a node represents the intensity with which the node participates in a community. Note that this provides for the edge probabilities output by dot product models to be interpretable in terms of co-participation in communities. In some cases, the vectors may have a sum-to-one requirement, which indicates that the node is assigned a categorical distribution over communities.

At operation 920, the system computes a predicted probability of an edge of the set of edges based on the first nonnegative matrix and the second nonnegative matrix using a machine learning model that represents a homophilous cluster and a heterophilous cluster. In some cases, the operations of this step refer to, or may be performed by, a machine learning model as described with reference to FIGS. 2 and 3.

At operation 925, the system updates parameters of the machine learning model based on the predicted probability of the edge. In some cases, the operations of this step refer to, or may be performed by, a training component as described with reference to FIG. 2.

Given an input graph A∈{0,1}^{n×n}, B and C are obtained such that the machine learning model produces Ã=σ(BB^{T}−CC^{T})∈(0,1)^{n×n}. Ã approximately matches A. The machine learning model is trained to minimize the sum of binary cross-entropies of the link predictions over the pairs of nodes:

R=−Σ(A log(Ã)+(1−A)log(1−Ã)) (6)

where Σ denotes the scalar summation of entries in the matrix. The training component is configured to fit the parameters using gradient descent over the loss (Eq. 6), as well as L₂ regularization of the factors B and C, subject to the nonnegativity of B and C.

According to an embodiment of the present disclosure, principled initialization of factors B and C is performed. Alternatively, random initialization of factors B and C may be used. The training component selects a total number of clusters k, and then automatically sets a split of homophilous/heterophilous clusters k_{B}/k_{C} such that k_{B}+k_{C}=k. The training component, via algorithm 1400 shown in FIG. 14, fits the logistic principal components analysis (LPCA) model to the input graph, yielding unconstrained factors X and Y. Then the training component processes the unconstrained factors into nonnegative initializations for B and C, while a non-stochastic version of the fitting and initialization algorithms is outlined, each component can generalize to a stochastic version, e.g., by sampling links and non-links for the loss function.

In some examples, the number of these communities is fixed (e.g., 3 communities in FIG. 6). Then the training component fits the model to maximize the likelihood of the known links. In doing so, for each community, the machine learning model learns its members and the factors by which membership changes the odds of a link. That is, the training component fines a parametrization of the machine learning model. The machine learning model is trained using gradient descent, on a cross-entropy loss. The training may extend to online setting.

According to an embodiment, the trained machine learning model can predict unknown data, e.g., the probabilities of unknown links which correspond to unknown attributes of users. The prediction is explainable. For example, user i will buy product j because that user and product participate in clusters a and b, and these communities change the odds of a link by factors x and y.

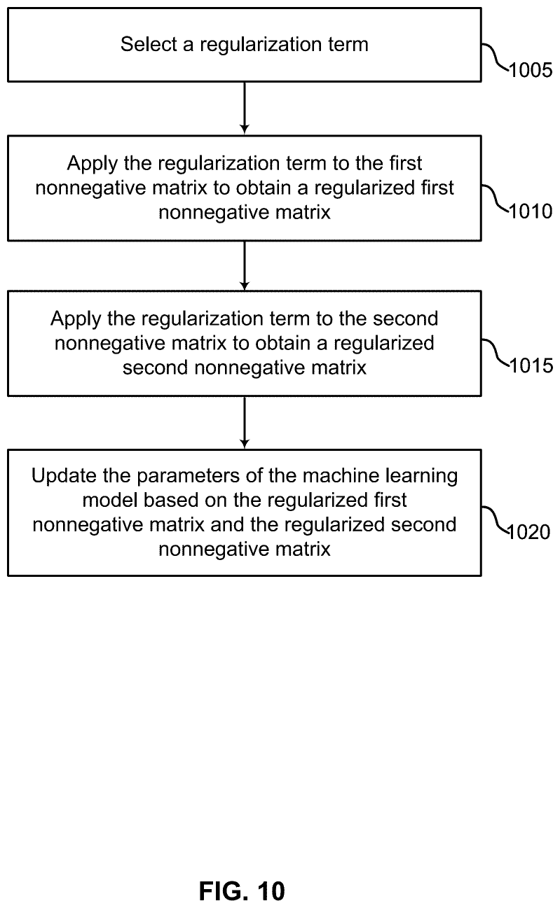

FIG. 10 shows an example of a regularization process according to embodiments of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with embodiments of the present disclosure. In some cases, the operations described herein are composed of various substeps, or are performed in conjunction with other operations.

At operation 1005, the system selects a regularization term. In some cases, the operations of this step refer to, or may be performed by, a training component as described with reference to FIG. 2. For example, a regularization term is denoted as lambda or λ as shown in FIG. 14, algorithm 1400. In some examples, the regularization weight λ may be set equal to 10.

At operation 1010, the system applies the regularization term to the first nonnegative matrix to obtain a regularized first nonnegative matrix. In some cases, the operations of this step refer to, or may be performed by, a training component as described with reference to FIG. 2. In some examples, the regularized first nonnegative matrix is denoted as B*.

At operation 1015, the system applies the regularization term to the second nonnegative matrix to obtain a regularized second nonnegative matrix. In some cases, the operations of this step refer to, or may be performed by, a training component as described with reference to FIG. 2. In some examples, the regularized second nonnegative matrix is denoted as C*.

According to an embodiment, algorithm 1400 (shown in FIG. 14) is derived based on Lemma 1 and constitutes a constructive proof of Theorem 1. Algorithm 1400 depends on computing the top-O(k) eigenvectors of

$$L = \frac{1}{2} ( {XY}^{T} + {YX}^{T} ) ,$$

which demonstrates O(nk) time matrix-vector multiplication. Thus, the eigenvectors can be computed efficiently using an iterative method. Algorithm 1400 generates nonnegative matrices using the regularization weight and eigenvalues/eigenvectors. For example, the regularization weight and eigenvalues/eigenvectors can be obtained based on logit factors X, Y∈ [symbol] ^{k×k}. Further, algorithm 1400 executes Q⁺×diag(\sqrt{+λ⁺}) to assign value to a regularized first nonnegative matrix B*. Furthermore, the algorithm executes Q⁻×diag(\sqrt{−λ⁻}) to assign value to a regularized second nonnegative matrix C*. Here, λ⁺, Q⁺ are positive eigenvalues/eigenvectors and λ⁻, Q⁻ are negative eigenvalues/eigenvectors.

At operation 1020, the system updates the parameters of the machine learning model based on the regularized first nonnegative matrix and the regularized second nonnegative matrix. In some cases, the operations of this step refer to, or may be performed by, a training component as described with reference to FIG. 2.

According to an embodiment, the nonnegative matrices B, C for the machine learning model are updated based on the regularized first nonnegative matrix and regularized second nonnegative matrices B*, C*. In some cases, unconstrained factors X, Y for the LPCA model can be processed into symmetric and nonnegative factors B, C for the machine learning model without any approximation error, at the cost of increasing the factorization rank. Therefore, for initialization of the 3k communities generated, the top k are kept which are most impactful on edge logits, as ranked by the L₂ norms of the columns of B and C. Now B∈ [symbol] ₊^{n×k}^{_{B}} and C∈ [symbol] ₊^{n×k}^{_{C}} such that k_{B}+k_{C}=k. The k communities are then optimized for initialization.

For example, Lemma 2 relates to exact LPCA embeddings for bounded-degree graphs. Let A∈{0,1}^{n×n} be the adjacency matrix of a graph G with maximum degree c. Then there exist matrices X, Y∈ [symbol] ^{n×(2c+1)} such that (XY^{T})ᵢⱼ>0 if Aᵢⱼ=1 and (XY^{T})ᵢⱼ<0 if Aᵢⱼ=0.

For example, Theorem 2 relates to exact reconstruction via nonnegative logits for bounded-degree graphs. Let A∈{0,1}^{n×n} be the adjacency matrix of a graph G with maximum degree c. Let k=12c+6. For any ϵ>0, there exist V∈[0,1]^{n×k} and diagonal W∈ [symbol] ^{k×k} such that ∥σ(VWV^{T})−A∥_{F}<ϵ.

Theorem 2 results from combining Theorem 1 and Lemma 2. Theorem 2 refers to the capacity of machine learning model 220. Lemma 2 and Theorem 2 are obtained from a constructive proof based on polynomial interpolation. Algorithm 1300 is based on cross-entropy gradient descent and employs regularization and uses fewer communities than the above upper bound on k.

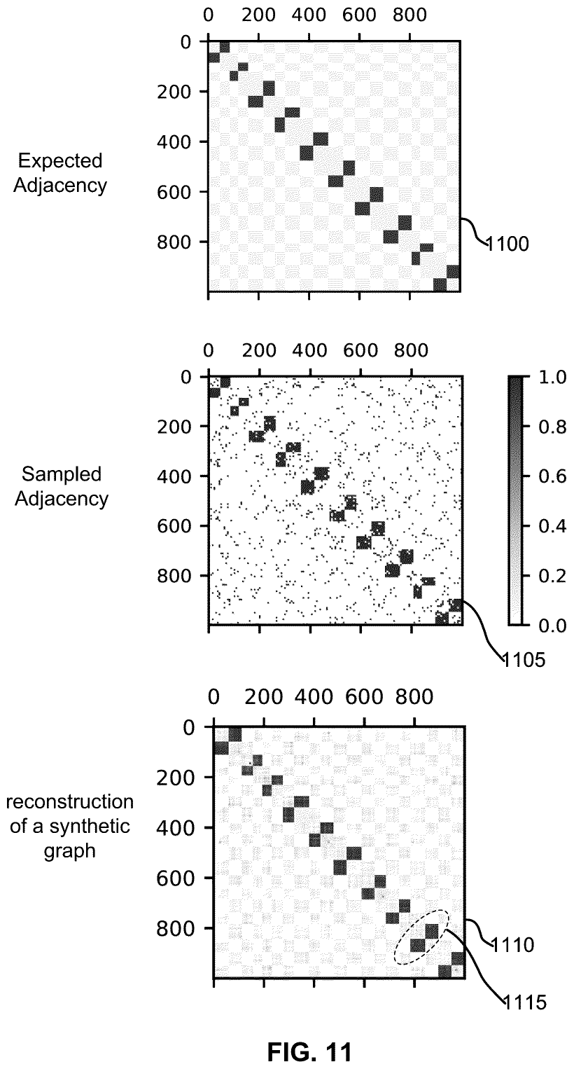

FIG. 11 shows an example of synthetic graph reconstruction 1110 according to embodiments of the present disclosure. The example shown includes expected adjacency 1100, sampled adjacency 1105, reconstruction 1110, and cluster 1115. Cluster 1115 is an example of, or includes embodiments of, the corresponding element described with reference to FIG. 12.

In some cases, graph models compress information about a graph (e.g., high-dimensional objects) using dot product models, which associate each node with a real-valued embedding vector. The predicted probability of a link between two nodes increases with the similarity of their embedding vectors. The models can be seen as factorizing an adjacency matrix of the graph in terms of low-rank matrices.

As an example shown in FIG. 11, an adjacency matrix is provided with 1000 nodes, which are randomly assigned to men or women and to one of ten cities. For example, the network may be a union of ten bipartite graphs, each of which may correspond to men and women at one of ten cities. The network can be recreated with machine learning model 220 (refer to FIG. 2) which accounts for homophilous and heterophilous structures in graphs, i.e., the model captures the heterophilous distinction between men and women. In some examples, a comparison can be done with low-rank approximation to the adjacency matrix in terms of Frobenius error which is a singular value decomposition (SVD) of the matrix that preserves the top singular values. Further, the machine learning model is shown to generate reconstruction that is closer to the true underlying graph. For example, if there are 10×2=20 different kinds of nodes, meaning the expected adjacency matrix is rank-20, and the machine learning model maintains low error for increased embedding length.

As shown in FIG. 11, expected adjacency 1100, sampled adjacency 1105, and reconstruction 1110 are provided. Sampled adjacency 1105 is used by the training algorithms for reconstructing the synthetic graph. In some examples, reconstruction 1110 of the synthetic graph may be performed using 12 communities or singular vectors and captures heterophilous interaction between men and women. In some embodiments, the machine learning model can reconstruct a graph using an embedding length that is linear in the graph's maximum degree.

FIG. 12 shows an example of synthetic graph decomposition according to embodiments of the present disclosure. The example shown includes first graph 1200, cluster 1205, and second graph 1210. Cluster 1205 is an example of, or includes embodiments of, the corresponding element described with reference to FIG. 11.

As an example shown in FIG. 12, machine learning model 220 generates factors by performing decomposition of the synthetic graph as in FIG. 11. In some examples, the decomposition is performed using 12 communities or singular vectors. For example, first graph 1200 and second graph 1210 represent the positive/negative eigenvalues corresponding to homophilous or heterophilous communities. Cluster 1205 of a set of clusters is used to reflect 10 cities, for example. Second graph 1210 captures heterophilous structure of the graph and reflects men and women.

According to an embodiment, the features generated by the machine learning model, i.e., the factors returned by factorization are visualized. The model factors capture the relevant latent structure in an interpretable way and can represent the homophilous and heterophilous structures.

FIG. 13 shows an example of fitting a constrained model according to embodiments of the present disclosure. Algorithm 1300 involves a function for fitting the constrained model. This function takes the adjacency matrix A∈{0,1}^{n×n}, regularization weight λ≥0, number of iterations I, initial homo- and hetero-philous assignments B∈ [symbol] ₊^{n×k}^{_{B}} and C∈ [symbol] ₊^{n×k}^{_{C}} as input and generates fitted factors B∈ [symbol] ₊^{n×k}^{_{B}} and C∈ [symbol] ₊^{n×k}^{_{C}} such that σ(BB^{T}−CC^{T})≈A as output. At line 1 of the algorithm, for 1 to I assigned to i, algorithm 1300 is executed to run lines 2-6. At line 2, σ(BB^{T}−CC^{T}) is executed to assign value to Ã. At line 3, −Σ(A log(Ã)+(1−A)log(1−Ã)) is executed to assign value to R. At line 4, R+λ(∥B∥_{F}²+∥C∥_{F}²) is executed to assign value to R. At line 5, ∂_{B,C}R is calculated via differentiation through lines 2 to 4. At line 6, B, C are updated to minimize R using ∂_{B,C}R, subject to B, C≥0. The value of B, C is returned.

FIG. 14 shows an example of converting LPCA factors according to embodiments of the present disclosure. Algorithm 1400 involves a function for converting LPCA factors to symmetric and nonnegative factors. This function takes logit factor X, Y∈ [symbol] ^{n×k} as input and generates B, C∈ [symbol] ₊^{n×3k} as output such that

$${BB}^{T} - {CC}^{T} \approx \frac{1}{2} ( {XY}^{T} + {YX}^{T} ) .$$

At line 1 of the algorithm, Q∈ [symbol] ^{n×k} and λ∈ [symbol] ^{k} is set by truncated eigendecomposition such that Q×

$$diag ( λ ) \times {Q}^{T} \approx \frac{1}{2} ( {XY}^{T} + {YX}^{T} ) .$$

At line 2, the algorithm executes Q⁺×diag(\sqrt{+λ⁺}) to assign value to B*, where λ⁺, Q⁺ are positive eigenvalues/eigenvectors. At line 3, Q⁻×diag(\sqrt{−λ⁻}) is executed to assign value to C*, where λ⁻, Q⁻ are negative eigenvalues/eigenvectors. At line 4, the algorithm executes (\sqrt{2}ϕ(B*); (\sqrt{2}ϕ(−B*); |C*|) to assign value to B, where ϕ and |⋅| are entrywise ReLU and absolute value. At line 5, (\sqrt{2}ϕ(C*); (\sqrt{2}ϕ(−C*); |B*|) are executed to assign value to C. At line 6, the value of B, C is returned.

Performance of apparatus, systems and methods of the present disclosure have been evaluated, and results indicate embodiments of the present disclosure have obtained increased performance over existing technology. Example experiments demonstrate that data augmentation apparatus 235 of the present disclosure outperforms conventional systems.

Embodiments of the present disclosure include a data augmentation apparatus that can capture arbitrary homophilous and heterophilous structures. The present disclosure provides methods, systems, and apparatus to generate an interpretable graph generative model based on nonnegative matrix factorization that is expressive at representing both homophily and heterophily, while maintaining simplicity and interpretability.

According to an embodiment, the data augmentation apparatus uses PyTorch for automatic differentiation and minimizes loss using the SciPy implementation of an optimization algorithm. In some examples, a limited memory Broyden-Fletcher-Goldfarb-Shanno (L-BFGS) algorithm is used with default hyperparameters and a maximum of 200 iterations of optimization.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving a dataset that includes a plurality of nodes and a plurality of edges, wherein each of the plurality of edges connects two of the plurality of nodes;
computing a first nonnegative matrix representing a homophilous cluster affinity;
computing a second nonnegative matrix representing a heterophilous cluster affinity;
computing a probability of an additional edge based on the dataset using a machine learning model that represents a homophilous cluster and a heterophilous cluster based on the first nonnegative matrix and the second nonnegative matrix; and
generating an augmented dataset including the plurality of nodes, the plurality of edges, and the additional edge.

2. The method of claim 1, further comprising:
providing a content item to a user based on the augmented dataset, wherein the user and the content item are represented by the plurality of nodes.

3. The method of claim 1, further comprising:
adding the additional edge to the dataset to obtain the augmented dataset.

4. The method of claim 1, further comprising:
computing a first product of the first nonnegative matrix and a transpose of the first nonnegative matrix;
computing a second product of the second nonnegative matrix and a transpose of the second nonnegative matrix;
computing a difference between the first product and the second product to obtain a symmetric difference matrix; and
applying a nonnegative nonlinear function to the symmetric difference matrix, wherein the probability of the additional edge is based on the nonnegative nonlinear function.

5. The method of claim 1, further comprising:
identifying a number of clusters, wherein a sum of a dimension of the first nonnegative matrix and a dimension of the second nonnegative matrix is equal to the number of clusters.

6. The method of claim 1, further comprising:
computing a first factor matrix and a second factor matrix, wherein the first factor matrix or the second factor matrix includes a negative value, and wherein the first nonnegative matrix and the second nonnegative matrix are computed based on the first factor matrix and the second factor matrix.

7. The method of claim 1, further comprising:
computing a cluster affinity matrix based on the first nonnegative matrix and the second nonnegative matrix, wherein the machine learning model includes the cluster affinity matrix.

8. A method comprising:
receiving a dataset that includes a plurality of nodes and a plurality of edges, wherein each of the plurality of edges connects two of the plurality of nodes;
computing a first nonnegative matrix representing a homophilous cluster affinity;
computing a second nonnegative matrix representing a heterophilous cluster affinity;
computing a predicted probability of an edge of the plurality of edges based on the first nonnegative matrix and the second nonnegative matrix using a machine learning model that represents a homophilous cluster and a heterophilous cluster; and
updating parameters of the machine learning model based on the predicted probability of the edge.

9. The method of claim 8, further comprising:
adding an additional edge to the dataset to obtain an augmented dataset.

10. The method of claim 8, further comprising:
computing a first product of the first nonnegative matrix and a transpose of the first nonnegative matrix;
computing a second product of the second nonnegative matrix and a transpose of the second nonnegative matrix;
computing a difference between the first product and the second product to obtain a symmetric difference matrix; and
applying a nonnegative nonlinear function to the symmetric difference matrix, wherein the predicted probability of the edge is based on the nonnegative nonlinear function.

11. The method of claim 8, further comprising:
identifying a number of clusters, wherein a sum of a dimension of the first nonnegative matrix and the second nonnegative matrix is equal to the number of clusters.

12. The method of claim 8, further comprising:
computing a first factor matrix and a second factor matrix, wherein the first factor matrix or the second factor matrix includes a negative value, and wherein the first nonnegative matrix and the second nonnegative matrix are computed based on the first factor matrix and the second factor matrix.

13. The method of claim 8, further comprising:
computing a cluster affinity matrix based on the first nonnegative matrix and the second nonnegative matrix, wherein the machine learning model includes the cluster affinity matrix.

14. The method of claim 8, further comprising:
selecting a regularization term;
applying the regularization term to the first nonnegative matrix to obtain a regularized first nonnegative matrix; and
applying the regularization term to the second nonnegative matrix to obtain a regularized second nonnegative matrix, wherein the parameters of the machine learning model are updated based on the regularized first nonnegative matrix and the regularized second nonnegative matrix.

15. The method of claim 8, further comprising:
computing an L2 norm of a plurality of columns of the first nonnegative matrix; and
ranking the plurality of columns based on the L2 norm, wherein the predicted probability of the edge is computed based on the ranking.

16. The method of claim 8, further comprising:
computing an L2 norm of a plurality of columns of the second nonnegative matrix; and
ranking the plurality of columns of the second nonnegative matrix based on the L2 norm, wherein the predicted probability of the edge is computed based on the ranking.

17. An apparatus comprising:
a processor;
a memory including instructions executable by the processor;
a machine learning model configured to compute a probability of an additional edge for a dataset that includes a plurality of nodes and a plurality of edges based on a first nonnegative matrix representing a homophilous cluster affinity and a second nonnegative matrix representing a heterophilous cluster affinity, wherein the machine learning model represents a homophilous cluster and a heterophilous cluster of the plurality of nodes; and
a data augmentation component configured to generate an augmented dataset including the plurality of nodes, the plurality of edges, and the additional edge.

18. The apparatus of claim 17, further comprising:
a cluster affinity component configured to compute a cluster affinity matrix based on the first nonnegative matrix and the second nonnegative matrix, wherein the machine learning model includes the cluster affinity matrix.

19. The apparatus of claim 17, further comprising:
a training component configured to update parameters of the machine learning model based on the probability of the additional edge.

20. The apparatus of claim 19, wherein:
the training component comprises a logistic principal components analysis (LPCA) model.
